(19) United States
(12) Patent Application Publication
(10) Pub. No.: US 2013/0048205 A1
(43) Pub. Date: Feb. 28, 2013

(54) METHOD FOR FORMING A FRAME

(71) Applicants: YI XIONG, Shenzhen City (CN); ZHI-HUA LIN, Shenzhen City (CN); JIN-BIAO PENG, Shenzhen City (CN)

(72) Inventors: YI XIONG, Shenzhen City (CN); ZHI-HUA LIN, Shenzhen City (CN); JIN-BIAO PENG, Shenzhen City (CN)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/303,396

(22) Filed: Nov. 23, 2011

(30) Foreign Application Priority Data
Aug. 29, 2011 (CN) 201110250772.7

(51) Int. Cl. B29C 65/72; B32B 38/00

(52) U.S. Cl. 156/245

(57) ABSTRACT

A method for forming a frame includes: (1) providing a thermosetting strip-shaped matrix material and a mandrel, and rolling the strip-shaped matrix material onto the mandrel to form a matrix body; (2) cutting the matrix body to form a plurality of preformed bodies, each having a predetermined height H; (3) providing a mold having a core, the shape of the core corresponding to the shape of the frame, and sleeving the preformed body on the core; (4) putting the mold to a hot press device, and hot pressing the preformed body to form the frame; (5) taking out the frame from the mold.

### BACKGROUND

1. Technical Field

The present disclosure relates to methods for forming a frame, and more particularly, to a method for forming a frame made of thermosetting materials.

2. Description of Related Art

Generally, a method for forming a frame made of thermosetting materials, such as thermosetting resin matrix composite materials, includes the following steps. First, a parent material is cut to a plurality of lamellas. Second, several lamellas are overlapped together and are put to a punching machine. Third, the overlapped lamellas are punched to form a preformed frame. Finally, the preformed frame is hot pressed in a hot press machine to form the frame.

However, the properties of the raw materials of the frame may be changed by the punching, such as the length of the macro-fibers of the thermosetting resin matrix composite materials is shortened when the micro-fibers are being cut into short fibers, and this decreases the mechanical strength of the frame. In addition, much of raw materials are wasted.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead placed upon clearly illustrating the principles of the present disclosure. Moreover, in the drawings, like reference numerals designate corresponding parts throughout the several views. Wherever possible, the same reference numerals are used throughout the drawings to refer to the same or like elements of an embodiment.

FIG. 1 is a flowchart of an embodiment of a method for forming a frame.

FIG. 2 is a schematic view of the frame manufactured by the method of FIG. 1.

FIG. 3 is a schematic view of a strip-shaped matrix material rolled onto a mandrel for manufacturing a matrix body prepared for forming the frame shown in FIG. 2.

FIG. 4 is a schematic view of the matrix body prepared for forming the frame shown in FIG. 2.

FIG. 5 is a schematic view of a preformed body prepared for forming the frame shown in FIG. 2.

FIG. 6 is a top-plane view of a mold with a preformed frame sleeved on a core of the mold prepared for forming the frame shown in FIG. 2.

### DETAILED DESCRIPTION

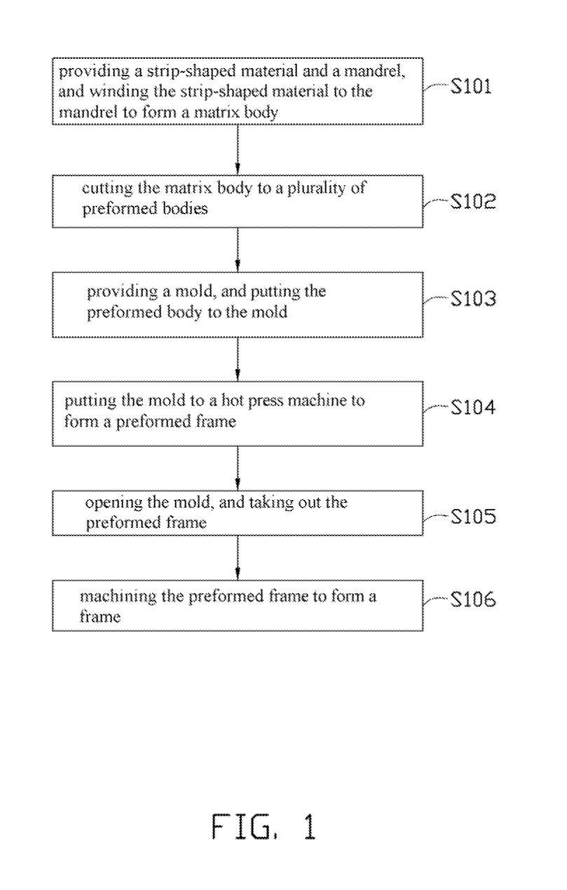

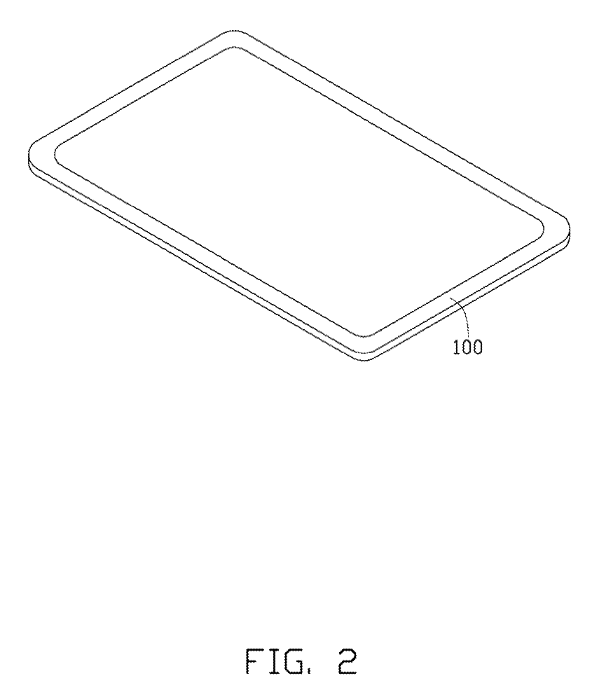

Referring to FIGS. 1 and 2, an embodiment of a method for forming a frame 100 made of thermosetting materials, such as thermosetting resin matrix composite materials or thermosetting polymer materials is shown. In the illustrated embodiment, the frame 100 is a rectangular frame made of thermosetting resin matrix composite material, such as resin matrix composite materials which contains a plurality of fibers selected from a group consisting of carbon fiber, glass fiber and kevlar fiber. The frame 100 defines a hollow section 101 in the center. The method of forming the frame 100 includes the following steps.

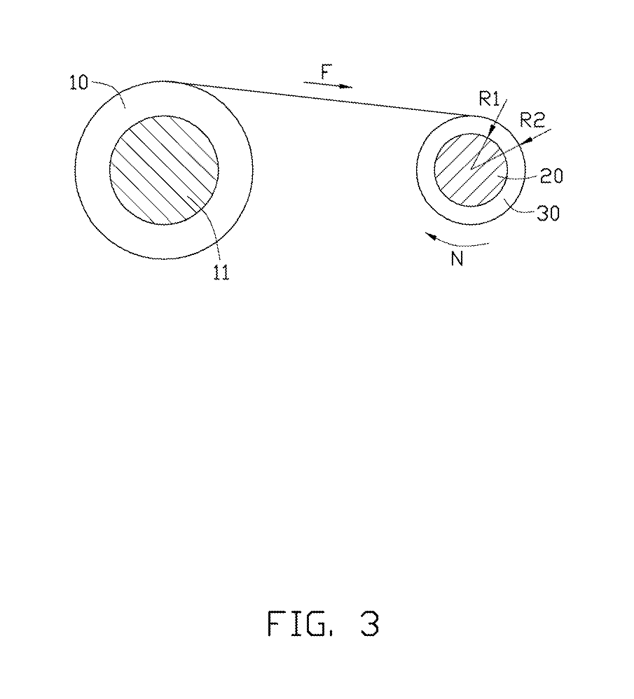

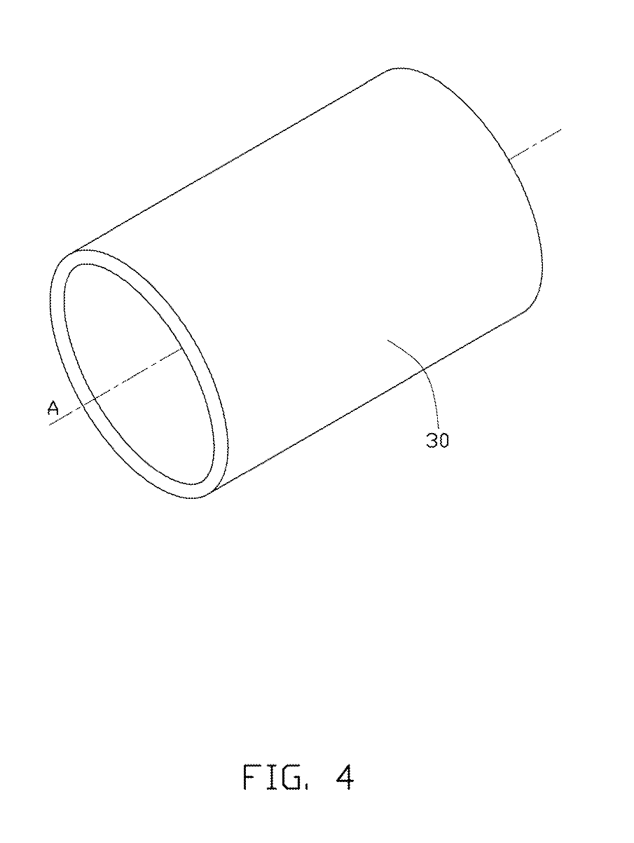

Referring also to FIGS. 3 and 4, in step S101, a strip-shaped matrix material 10 and a mandrel 20 are provided for forming the frame 100. The strip-shaped matrix material 10 is made of a plurality of thermosetting resin matrix composite materials. In the illustrated embodiment, the strip-shaped matrix material 10 is a carbon fiber prepreg cloth, and is banded on a columnar fixing member 11 in a shape of a cylinder. The mandrel 20 is cylindrical-shaped, and is fixed to a winder (not shown). The strip-shaped matrix material 10 is rolled onto the mandrel 20 via the winder to form a matrix body 30 having a predetermined thickness and a predetermined inner diameter according to a shape of the frame 100. In order to achieve the predetermined thickness and the predetermined inner diameter of the matrix body 30 shown in FIG. 4 to form the frame, an outer radius R1 of the mandrel 20 and an outer radius R2 of the matrix body 30 can be calculated depending on the following: an internal shrinkage ratio of the strip-shaped matrix material 10, a thickness of each strip-shaped matrix material 10, a size of the frame 100, and a number of revolutions N of the strip-shaped matrix material 10 rolled onto the mandrel 20. The strip-shaped matrix material 30 is rolled onto the mandrel 20 by a predetermined drawing force F.

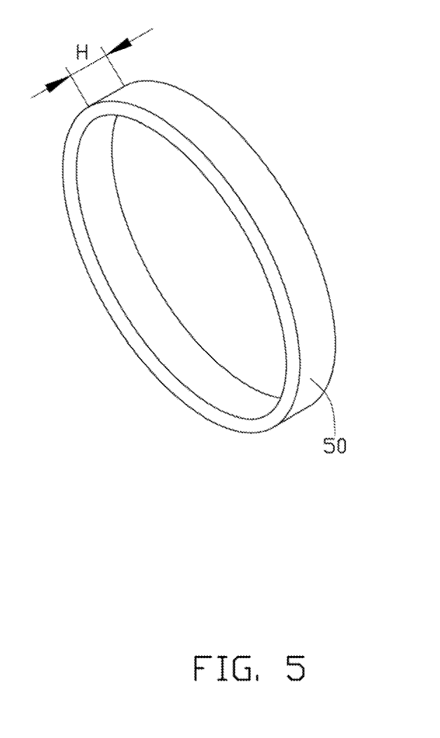

Referring also to FIGS. 4 and 5, in step S102, the matrix body 30 is being cut to form a plurality of preformed bodies 50 having a predetermined height H. In the illustrated embodiment, the matrix body 30 is fixed to a reel slitter (not shown), and the reel slitter slits the matrix body 30 along a direction perpendicular to the axis A of the matrix body 30.

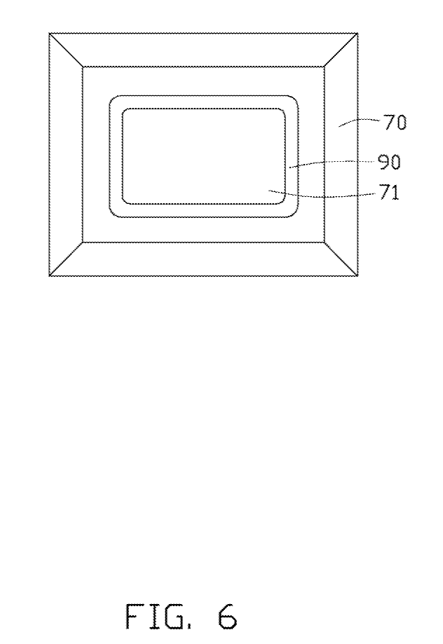

Referring to FIGS. 2 and 6, in step S103, a mold 70 is provided. The mold 70 defines a core 71 and a cavity (not shown) surrounding the core 71. The core 71 is a rectangular protrusion, and the shape of the core 71 is configured so as to allow for mating with the hollow section 101 defined by the frame 100. The shape of the cavity is corresponds to the shape of the frame 100. One preformed body 50 is sleeved onto the core 71 and received in the cavity. It should be pointed out that some parting or releasing agent can be coated on the core 71 for allowing for stripping the frame 100 more easily.

In step S104, the mold 70 is closed, and put into a hot press machine (not shown) for performing hot pressing at a predetermined temperature, a predetermined pressure, and a predetermined time to form a preformed frame 90. The predetermined temperature, the predetermined pressure, and the predetermined time can be controlled in the hot press machine according to the specific materials of the strip-shaped matrix material 10.

In step S105, the mold 70 is opened, and the preformed frame 90 is taken out.

Also referring to FIG. 1, in step S106, the preformed frame 90 is machined by a machine (not shown), thus the frame 100 is thereby obtained. In the illustrated embodiment, the machine is a deburrer, used for deburring the preformed frame 90.

It can be pointed out that the frame 100 can be of other shapes, such as a triangle. At this time, the shape of the core 71 and the cavity changes correspondingly. In the case that the size of the preformed frame 90 already satisfies the needed size requirement, the step S106 can be omitted. The mold 70 can be multi-layered mold, thus multiple number of preformed bodies 50 can be hot pressed at the same time. In the situation in which the height of the matrix body 50 is H, the step S102 can be omitted.

The properties of the frame 100 would not be negatively affected during the process. Each preformed body 50 can be formed to a frame 100 after hot pressing and machining, thus achieving a high efficiency. Because the strip-shaped matrix material 10 is rolled onto the mandrel 20 to form the matrix body 30, as a result, the strip-shaped matrix material 10 is not wasted.

It is to be understood that the present disclosure is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for forming a frame defining a hollow section, comprising:
providing a strip-shaped matrix material made of thermosetting material, and a mandrel;
rolling the strip-shaped matrix material onto the mandrel to form a matrix body having a predetermined thickness and a predetermined inner diameter according to a shape of the frame;
cutting the matrix body to form a plurality of preformed bodies;
providing a mold defining a core and a cavity surrounding the core, the shape of the core is configured to be corresponding to the shape of the hollow section, and sleeving the preformed body on the core, the shape of the cavity corresponding to the shape of the frame, and receiving the preformed body;
closing the mold and putting the mold to a hot press machine, and hot pressing the preformed body at a predetermined temperature, a predetermined pressure, and a predetermined time to form a preformed frame; and
taking out the preformed frame from the mold.

2. The method for forming a frame of claim 1, wherein the strip-shaped matrix material is thermosetting resin matrix composite material.

3. The method for forming a frame of claim 1, wherein the mandrel is a cylinder; the preformed body is a hollow cylinder.

4. The method for forming a frame of claim 1, wherein an inner radius and an outer radius of the matrix body are calculated depending on an internal shrinkage ratio, a thickness of the strip-shaped matrix material, a size of the frame, and a number of revolutions of the strip-shaped matrix material rolled onto the mandrel; the inner radius and the outer radius of the matrix body dictate the thickness of the preformed body.

5. The method for forming a frame of claim 1, wherein the mold is a multilayered mold;
a plurality of preformed bodies are put into the mold and hot pressed to form a plurality of frames at the same time.

6. A method for forming a frame defining a hollow section, comprising:
providing a strip-shaped matrix material made of thermosetting material and a mandrel,
rolling the strip-shaped matrix material onto the mandrel to form a matrix body having a predetermined thickness and a predetermined inner diameter according to a shape of the frame, the length of the matrix body equaling the width of the roll of the strip-shaped matrix material;
cutting the matrix body to form a plurality of preformed bodies;
providing a mold defining a core and a cavity surrounding the core, the shape of the core is configured to be corresponding to the shape of the hollow section, and sleeving the preformed body on the core, the shape of the cavity corresponding to the shape of the frame, and receiving the preformed body;
closing the mold and putting the mold to a hot press machine, and hot pressing the preformed body at a predetermined temperature, a predetermined pressure, and a predetermined time to form a preformed frame;
taking out the preformed frame from the mold, the preformed frame having a similar size with the frame; and
machining the preformed frame to form the frame.

7. The method for forming a frame of claim 6, wherein the strip-shaped matrix material is thermosetting resin matrix composite material.

8. The method for forming a frame of claim 6, wherein the mandrel is a cylinder; the preformed body is a hollow cylinder.

9. The method for forming a frame of claim 6, wherein an inner radius and an outer radius of the matrix body are calculated depending on an internal shrinkage ratio, a thickness of the strip-shaped matrix material, a size of the frame, and a number of rolling revolutions of the strip-shaped matrix material rolled onto the mandrel; the inner radius and the outer radius of the matrix body dictate the thickness of the preformed body.

10. The method for forming a frame of claim 6, wherein the mold is a multilayered mold, and a plurality of preformed bodies are put into the mold and hot pressed to form a plurality of frames at the same time.
